(19) United States
(12) Patent Application Publication
(10) Pub. No.: US 2007/0041144 A1
(43) Pub. Date: Feb. 22, 2007

(54) Method for reducing substrate noise from penetrating noise sensitive circuits

(76) Inventors: Clement Szeto, Union City, CA (US); Chong Woo, Fremont, CA (US)

Correspondence Address: HELLER EHRMAN LLP, 275 MIDDLEFIELD ROAD, MENLO PARK, CA, 94025-3506, US

(21) Appl. No.: 11/440,231

(22) Filed: May 23, 2006

Related U.S. Application Data
(60) Provisional application No. 60/683,976, filed on May 23, 2005.

(51) Int. Cl. H01G 4/255

(52) U.S. Cl. 361/272

(57) ABSTRACT

A CMOS device includes a p-type substrate and an isolated PWell region. An isolation region has an NWell region abutting a perimeter of the PWell region. The isolation region includes a DNWell region positioned below the PWell region and an NWell region. The NWell region forms a sidewall of a tub and the DNWell region forms a bottom of the tub. The tub is an n-type region that physically and electrically isolates an enclosed PWell region from the p-type substrate. A NTN region is formed in the p-type substrate and at least partially abuts an outer perimeter of the NWell region. The NTN region is defined as a non-PWell and a non-NWell region. The NTN region enhances electrical isolation of the circuits inside the PWell region from circuits outside of the PWell region. In one embodiment, the high-frequency performance of an NMOSFET inside the isolated PWell is improved because of the reduced sidewall capacitance with the NTN region.

### RELATED APPLICATIONS

This application claims the benefit of provisional application 60/683,976, filed May 23, 2005, which application is fully incorporated herein by reference.

### BACKGROUND

1. Field of the Invention

This invention relates generally to noise isolation of CMOS devices, and more particularly to a CMOS structural feature that reduces substrate coupling noise from penetrating noise sensitive circuits.

2. Description of the Related Art

Conventional N-Well (NW) and Deep N-Well (DNW) in a circuit are shown in FIG. 7. As illustrated, a P-Well (PW) region, which is typically an implanted retro-graded PW, normally abuts directly to the NW region. A MOSFET device is included in FIG. 7. A standard RF isolation technique utilizes the NW ring and the DNW base. The MOSFET sits within a standard PW doped silicon region, labeled RW, and isolated from the rest of the P-type substrate. The isolation is the NW ring in contact with the DNW base, and forms a “bathtub” of N-type doped material.

Current conventional CMOS design rules define the layer of NW areas to be drawn, while the PW areas are implicitly defined as the inverse of the NW areas. Occasionally, a native, or NTN, drawing layer is also used to define areas devoid of the PW doping.

FIGS. 1(a) through 1(c) illustrate the conventional use of a native, or NTN, layer to create a MOSFET with nearly zero threshold voltage. Current practice impose design rules enforcing a minimum spacing between NTN and NW as illustrated in FIGS. 1(a) through 1(c).

The requirement of this minimum spacing between NTN and NW implicitly forces the NW to be abutted by the PW. Due to the relatively high doping levels at this NW to PW sidewall junction, the sidewall junction capacitance is unnecessarily high, which is undesirable in regards to noise isolation and high-frequency performance.

There is a need for a CMOS device with increased impedance of the NW to PW sidewall junction for all frequencies. There is a further need for a CMOS device with increased impedance of the NW to PW sidewall junction for all frequencies by reducing the sidewall junction capacitance.

### SUMMARY

Accordingly, an object of the present invention is to provide a CMOS device with increased impedance of the NW to PW sidewall junction for all frequencies.

Another object of the present invention is to provide a CMOS device with increased impedance of the NW to PW sidewall junction for all frequencies by reducing the sidewall junction capacitance.

Yet another object of the present invention is to provide a CMOS device with increased impedance of the NW to PW sidewall junction for all frequencies by increasing the effective resistance in series with this junction capacitance.

A further object of the present invention is to provide a CMOS device with an improvement in noise isolation and high-frequency performance.

These and other objects of the present invention are achieved in a CMOS device that includes a p-type substrate and an isolated PWell region. An isolation region has an NWell region abutting a perimeter of the PWell region. The isolation region includes a DNWell region positioned below the PWell region and an NWell region. The NWell region forms a sidewall of a tub and the DNWell region forms a bottom of the tub. The tub is an n-type region that physically and electrically isolates an enclosed PWell region from the p-type substrate. A NTN region is formed in the p-type substrate and at least partially abuts an outer perimeter of the NWell region. The NTN region is defined as a non-PWell and a non-NWell region. The NTN region enhances electrical isolation of the circuits inside the PWell region from circuits outside of the PWell region. In one embodiment, the high-frequency performance of an NMOSFET inside the isolated PWell is improved because of the reduced sidewall capacitance with the NTN region.

In another embodiment of the present invention, a CMOS device includes an n-type substrate and an NWell region. An isolation region includes a PWell region abutting a perimeter of the NWell region. The isolation region includes a Deep-PWell region positioned below the NWell region and a PWell region. The PWell region forms a sidewall of a tub and the Deep-PWell region forms a bottom of the tub. The tub is a p-type region that physically and electrically isolates an enclosed NWell region from the n-type substrate. A NTN region is formed in the n-type substrate and is at least partially abutting an outer perimeter of the PWell region. The NTN region enhances the electrical isolation of the circuits inside the isolated NWell region from the circuits outside the isolated NWell region.

In another embodiment of the present invention, a CMOS device has a p-type substrate and an NWell region. A NTN region is formed in the p-type substrate and at least partially abuts an outer perimeter of the NWell region. The NTN region enhances the electrical isolation of the circuits inside the NWell region from circuits outside the NWell region.

In another embodiment of the present invention, a CMOS device has an n-type substrate and a PWell region. A NTN region is formed in the n-type substrate and at least partially abuts an outer perimeter of the PWell region. The NTN region enhances the electrical isolation of the circuits inside the PWell region from circuits outside the PWell region.

### BRIEF DESCRIPTION OF THE DRAWINGS

FIGS. 1(a) through 1(c) are schematic diagrams of a conventional use of a native, or NTN, layer to create a MOSFET with nearly zero threshold voltage.

FIG. 2 is a schematic diagram of an embodiment of a CMOS device of the present invention with a NTN region formed in a p-type substrate that at least partially abuts an outer perimeter of an NWell region.

FIG. 3 is a schematic diagram of an embodiment of a CMOS device of the present invention, similar to that of FIG. 2, but with an n-type substrate.

FIG. 4 is a schematic diagram of an embodiment of a CMOS device of the present invention that has a NTN region formed in a p-type substrate and at least partially abuts an outer perimeter of an NWell region.

FIG. 5 is a schematic diagram of an embodiment of a CMOS device of the present invention with a NTN region formed in an n-type substrate and at least partially abuts an outer perimeter of a PWell region.

FIG. 6 is a schematic diagram of an embodiment of the present invention with a lightly-doped silicon region, defined with an NTN layer that is used to create additional circuit isolation.

FIG. 7 is a schematic diagram of a conventional N-Well (NW) and Deep N-Well (DNW) in a circuit.

FIG. 8 is a schematic diagram illustrating that in one embodiment of the present invention a NTN region pulls a PW implant edge away from the a NW implant edge.

FIG. 9 is a schematic diagram illustrating that without a PW channel-stop, a parasitic field-oxide NMOSFET can form over the native lightly-doped p-type substrate.

FIG. 10 is a schematic diagram illustrating that in one embodiment of the present invention a PW acts as a channel-stop.

FIG. 11 is a schematic diagram that illustrates an embodiment of the present invention with a P+ OD ring in a PW region immediately surrounds an NTN ring which abuts a NW/DNW.

FIG. 12 is a schematic diagram illustrating that a P+OD/PW channel-stop breaks the native field-oxide NMOSFET with minimal side effects due to a NTN region of the present invention.

FIG. 13 illustrates in a graph that quantitatively a dynamic AC effect from a parasitic is small.

FIG. 14 illustrates in a graph that with an embodiment of the present invention an improvement in a frequency response is achieved due to a lower sidewall capacitance.

FIG. 15 illustrates a rough estimate of a sidewall capacitance reduction in one embodiment of the present invention.

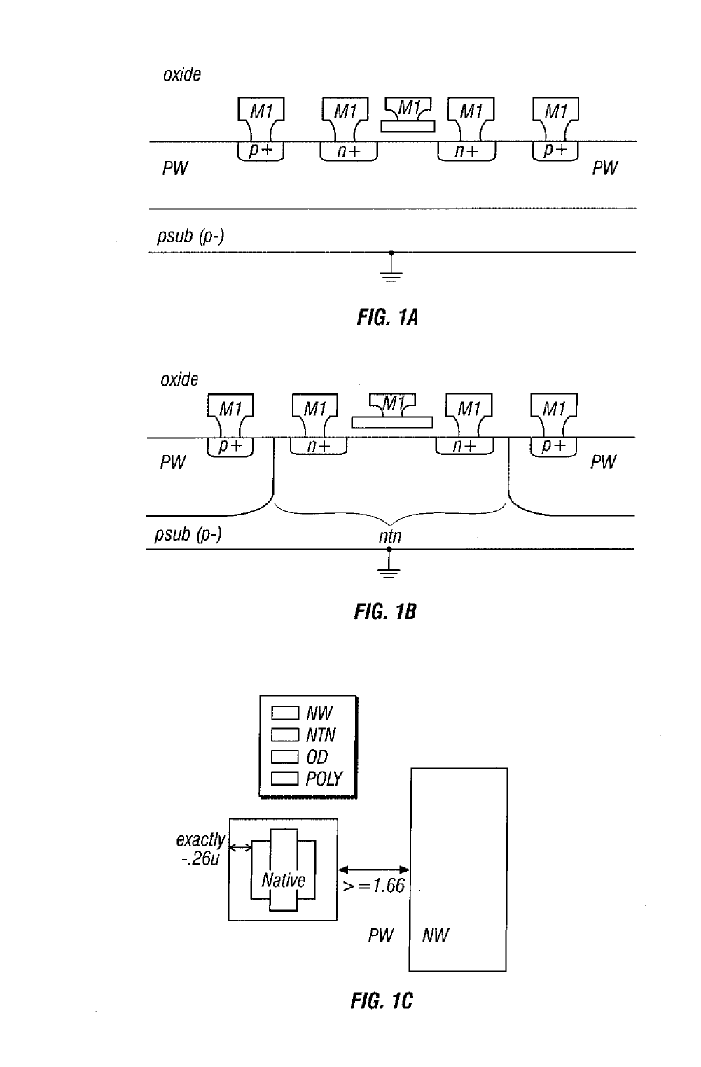

### DETAILED DESCRIPTION

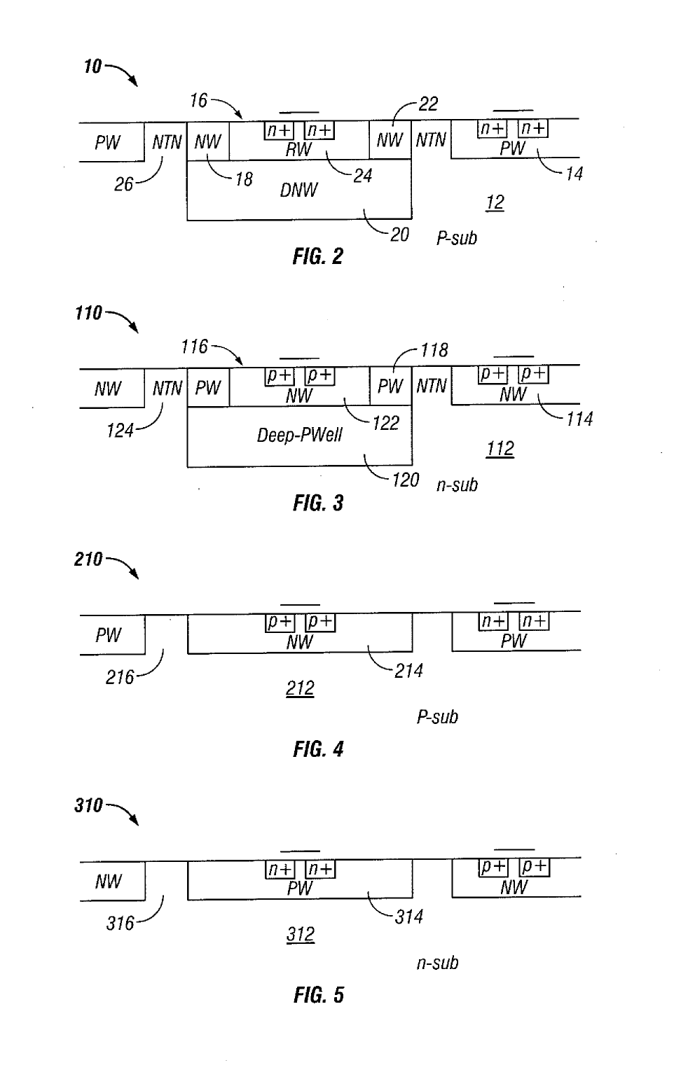

As illustrated in FIG. 2, in one embodiment of the present invention, a CMOS device 10 includes a p-type substrate 12 and a PWell region 14. An isolation region 16 has an NWell region 18 abutting a perimeter of the PWell region 14. The isolation region 16 includes a DNWell region 20 positioned below the PWell region 14 and an NWell region 22. The NWell region 22 forms a sidewall of a tub 24 and the DNWell region 20 forms a bottom of the tub 24. The tub 24 is an n-type region that physically and electrically isolates an enclosed PWell region 14 from the p-type substrate 12. A NTN region 26 is formed in the p-type substrate 12 and at least partially abuts an outer perimeter of the NWell region 22. In one embodiment, the NTT region is defined as a non-PWell and a non-NWell region. In another embodiment, the NTN region is defined as a region without PWell implants and without NWell implants.

The NTN region 26 increases impedance of PN junctions formed by the NWell and DNWell regions 22 and 20 to the surrounding p-type substrate 12. The NTN region 26 provides an enhanced level of electrical noise isolation. The NTN region 26 can have a lowered substrate doping than that of the PWell region 14. In one embodiment, the doping of the NTN region 26 is no more than about 10% of the doping of the PWell region 14 or the NWell 22 region that has the lower doping.

In one embodiment, the NTN region 26 increases an effective resistance in series with the PN junctions due to a lowered substrate doping. The NWell region 22 has a decreased sidewall capacitance. A lower perimeter capacitance of the NWell perimeter improves a higher frequency performance of an NMOSFET inside the PWell region 14.

The PWell region 14 acts as a channel-stop. The PWell region 14 breaks the formation of the parasitic native field-oxide NMOSFET. In one embodiment, at least one circuit inside the enclosed PWell region 14, and at least one circuit external to the NWell region 22. These circuits can be MOSFETS or passive devices.

As illustrated in FIG. 3, in another embodiment of the present invention, a CMOS device 110 includes an n-type substrate 112 and an NWell region 114. An isolation region 116 includes a PWell region 118 abutting a perimeter of the NWell region 114. The isolation region 116 includes a Deep-PWell region 120 positioned below the NWell region 114 and the PWell region 118. The PWell region 118 forms a sidewall of a tub 122 and the Deep-PWell region 118 forms a bottom of the tub 122. The tub 122 is a p-type region that physically and electrically isolates an enclosed NWell region 114 from the n-type substrate 112. A NTN region 124 is formed in the n-type substrate 112 and is at least partially abuts an outer perimeter of the PWell region 118. The NTN region 124 enhances the electrical isolation of the circuits inside the isolated NWell region 114 from the circuits outside the isolated NWell region 114.

As illustrated in FIG. 4, in another embodiment of the present invention, a CMOS device 210 has a p-type substrate 212 and an NWell region 214. A NTN region 216 is formed in the p-type substrate 212 and at least partially abuts an outer perimeter of the NWell region 214. The NTN region 216 enhances the electrical isolation of the circuits inside the NWell region 214 from circuits outside the NWell region 214.

As illustrated in FIG. 5, in another embodiment of the present invention, a CMOS device 310 has an n-type substrate 312 and a PWell region 314. A NTN region 316 is formed in the n-type substrate 312 and at least partially abuts an outer perimeter of the PWell region 314. The NTN region 316 enhances the electrical isolation of the circuits inside the PWell 314 region from circuits outside the PWell region 314.

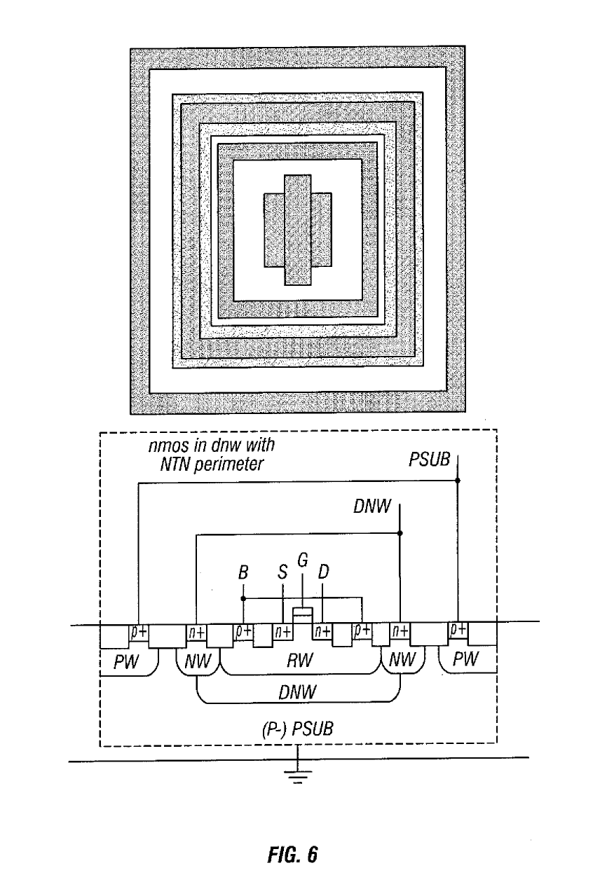

FIG. 6 is a diagram of one embodiment of the present invention, and illustrates how a lightly-doped silicon region, conveniently defined with the NTN layer is used to create additional circuit isolation. In this embodiment, the creation of the lightly-doped buffer region abutting the NW perimeter creates a mote between the NW and PW regions.

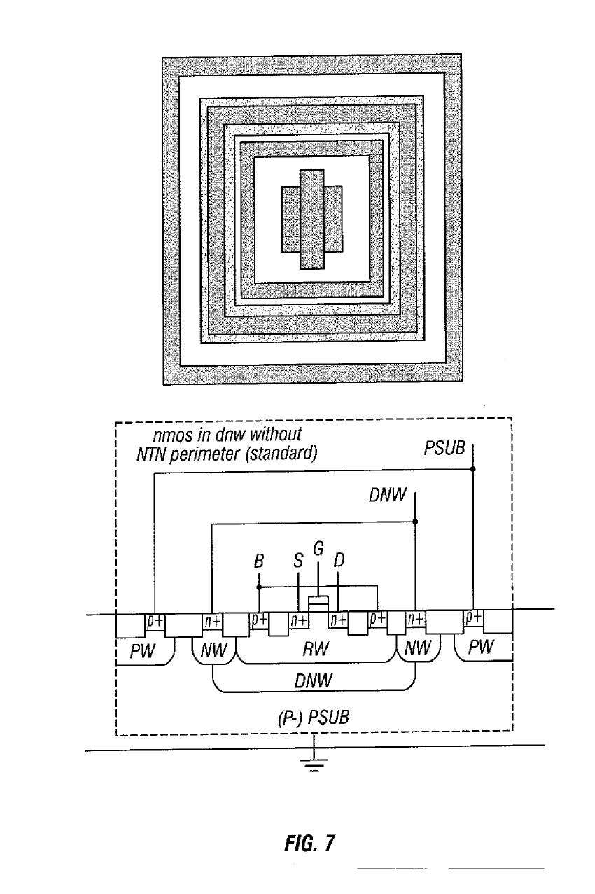

One embodiment of the present invention is illustrated in FIG. 6. Enhancement in the electrical isolation of a MOSFET from the rest of the circuits is achieved with the use of the NTN. FIG. 6 is similar to the convention embodiment in FIG. 7, except that a NTN ring abuts the NW outer perimeter. The NTN improves the isolation effect of the NW and DNW bathtub isolation region. The NTN acts as a further isolation ring, and is positioned between the NW ring and the surrounding PW material. The NTN blocks the PW implant.

The NTN ring is abutting the NW is a region normally occupied by PW material. Conventional design rules enforce PW to abutt NW, for instance, forcing the NW implant edge to coincide with the PW implant edge.

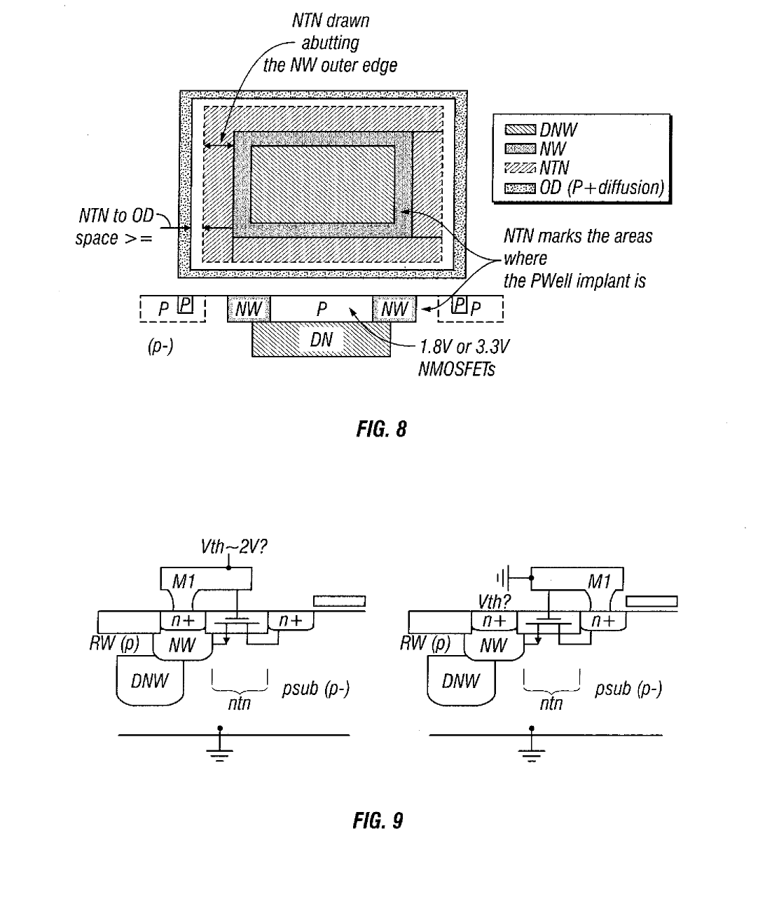

FIG. 8 highlights that the NTN ring pulls the PW implant edge away from the NW implant edge. In the new embodiment, the NTN ring provides an enhanced level of electrical noise isolation. This enhancement results from the lower substrate doping relative to the PW. As a result, the NW sidewall capacitance is decreased and the effective substrate resistance is increased. The effective isolation impedance is increased for all frequencies. Furthermore, the lower NW sidewall capacitance can improve the NMOSFET performance at higher frequencies.

FIG. 9 illustrates that without the PW channel-stop, a parasitic field-oxide NMOSFET can form over the native lightly-doped p-type substrate (psub). By way of illustration, and without limitation, for a 1 um effective silicon-dioxide thickness between aluminum metal-1 to psub, the calculated field threshold voltage (Vth) is ideally 1.7V to 2.6V for psub doping of 5e14 to 1e15 cm-3. Due to an unknown Vth shift, dictated by any uncontrollable field oxide surface charge, a field inversion channel over psub may turn on and off during signal swings, even if the M1 gate above the native psub is grounded at the lowest potential while the NW/DNW voltage is allowed to swing. This inversion channel can make an undesirable and uncontrollable electrical bridge between two n-type regions, which can be NW to NW, or NW to N+, the latter being illustrated in FIG. 9. This present invention prevents this connection where the parasitic field-oxide MOSFET forms an undesirable DC conduction path.

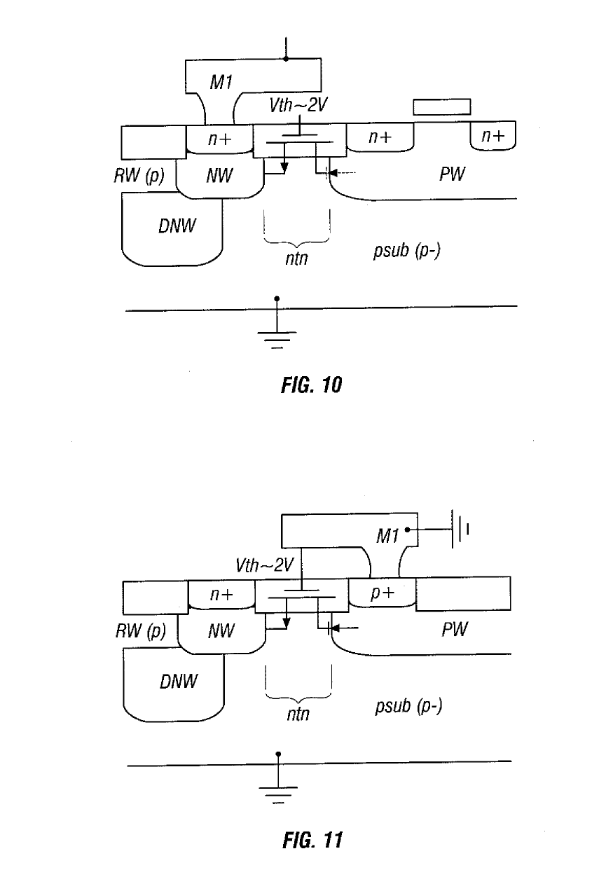

FIG. 10 illustrates how the PW acts as a channel-stop. The PW channel-stop breaks the formation of the parasitic native field-oxide NMOSFET. Except for leakages, a DC conduction path can not flow through the field-oxide NMOS structure having just the one-sided n-type source or drain. A NMOSFET requires both a source and a drain. In one embodiment of the present invention, a P+ OD ring in the PW immediately surrounds the NTN ring, which abuts the NW/DNW, as illustrated in FIG. 11.

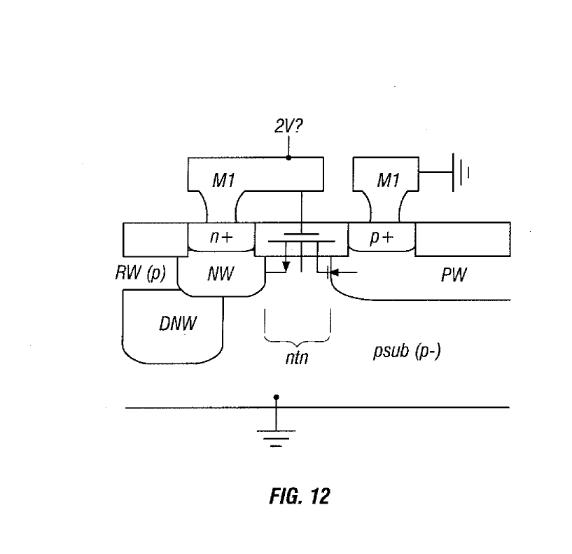

Referring now to FIG. 12, although the P+OD/PW channel-stop breaks the native field-oxide NMOSFET, side effects due to the NTN ring still exist. However, these side effects are negligible. For instance, an inversion channel formed under the NTN ring would be connected to the NW/DNW, and would be a parasitic charge storage loading the NW/DNW node.

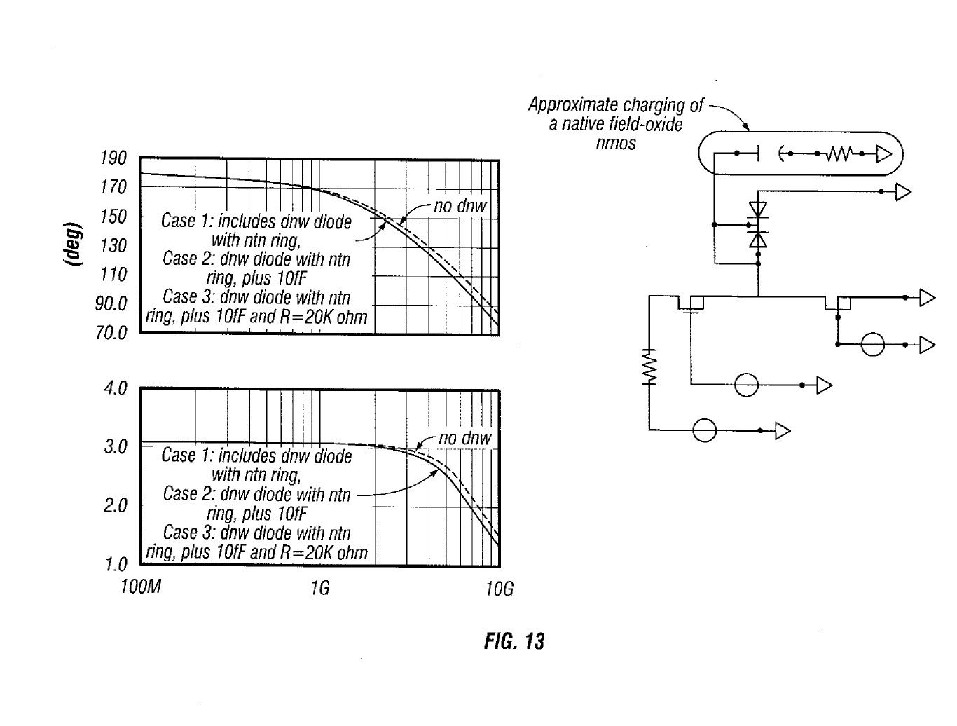

FIG. 13 shows quantitatively that the dynamic AC effect from this parasitic is small. Case 1 shows the AC response of the circuit without the native field-oxide NMOSFET parasitic. Case 2 shows the AC response of the circuit with the capacitive loading effects of the native field-oxide NMOSFET parasitic included. This loading is estimated to be 10 fF for the case of a 2 um wide native, or NTN, ring which encloses a PWell region that contains an NMOSFET with a gate width of 80*2.5 um and a gate length of 0.35 um. The difference in the AC response is shown to be less than 0.6% at 4 GHz. Case 3 shows that the difference will be even less than 0.6% if the resistance of about 20 kOhm for the native field-oxide NMOSFET channel is also considered.

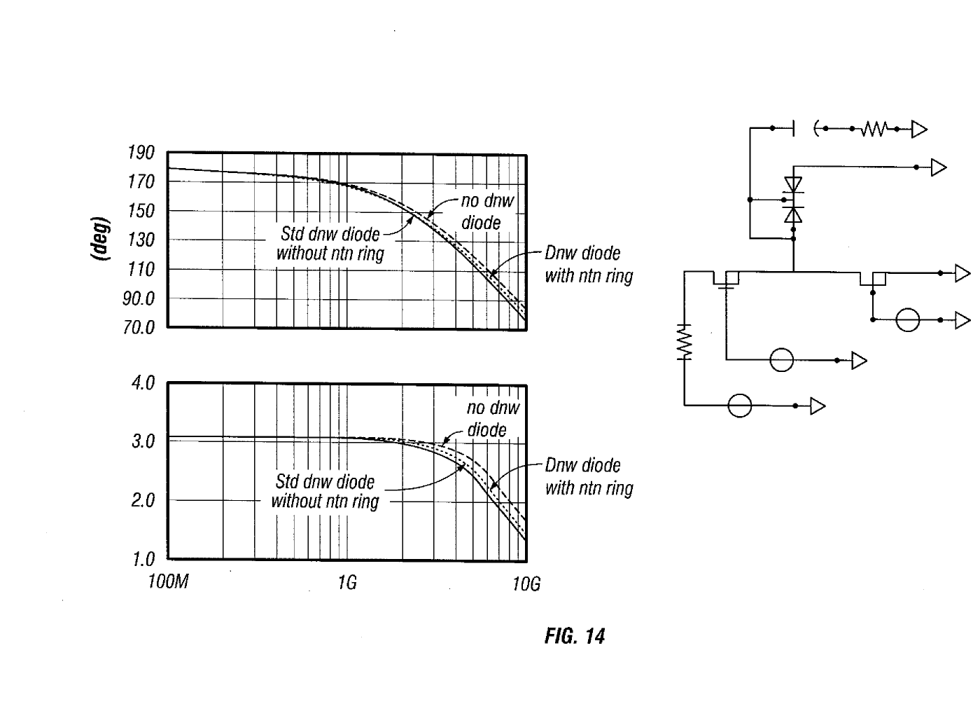

In contrast, with the NTN ring of the present invention, FIG. 14 shows that an improvement in the frequency response is achieved due to the lower sidewall capacitance. FIG. 14 shows than the difference in the AC response for the DNW diode without the NTN ring and with the NTN ring is about 4% at 4 GHz.

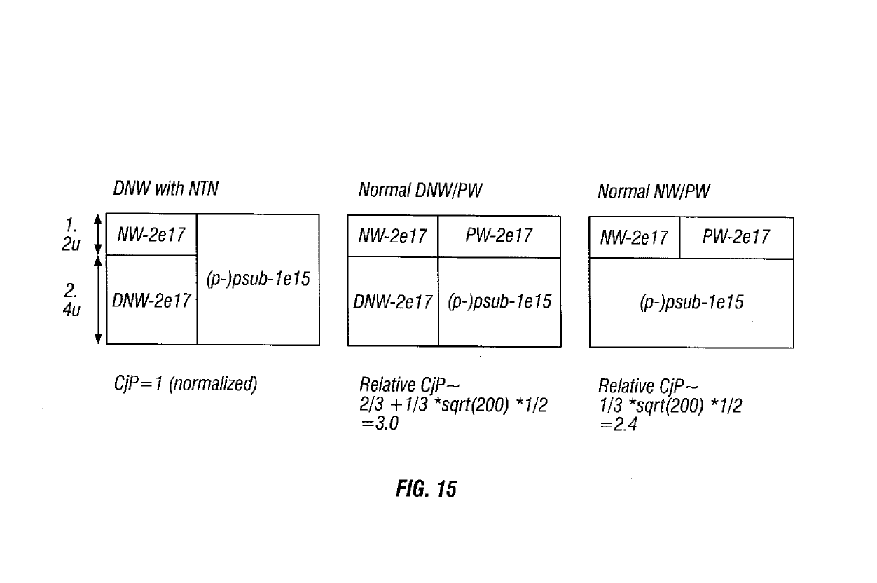

FIG. 15 provides a rough estimate of the sidewall capacitance reduction. In the case of the normal DNW/PW structure the NTN ring is shown to reduce the sidewall capacitance by a factor of 3. For the case of the normal NW/PW structure the NTN ring is shown to reduce the sidewall capacitance by a factor of 2.4.

The dimensions and ranges herein are set forth solely for the purpose of illustrating typical device dimensions. The actual dimensions of a device constructed according to the principles of the present invention may obviously vary outside of the listed ranges without departing from those basic principles.

Further, it should be apparent to those skilled in the art that various changes in form and details of the invention as shown and described may be made. It is intended that such changes be included within the spirit and scope of the claims appended hereto.

What is claimed is:

1. A CMOS device, comprising:
a p-type substrate;
a PWell region;
an isolation region that includes an NWell region abutting a perimeter of the PWell region, the isolation region including a DNWell region positioned below the PWell region and an NWell region, the NWell region forming a sidewall of a tub and the DNWell region forming a bottom of the tub, the tub being an n-type region that physically and electrically isolates an enclosed PWell region from the p-type substrate;
a NTN region formed in the p-type substrate and at least partially abutting an outer perimeter of the NWell region;
wherein the NTN region enhances the electrical isolation of the circuits inside the isolated PWell region from the circuits outside of the isolated PWell region.

2. The device of claim 1, wherein the NTN region is defined as a non-PWell and a non-NWell region.

3. The device of claim 1, wherein the NTN region is defined as a region without PWell implants and without the NWell implants.

4. The device of claim 1, wherein the circuits may include IC transistors, such as MOSFETs and bipolar transistors, or passive devices, such as IC resistors, capacitors, and inductors.

5. The device of claim 1, wherein the NTN region increases impedance of PN junctions formed by the NWell and DNWell regions to the surrounding p-type substrate.

6. The device of claim 5, wherein the NTN region provides an enhanced level of electrical noise isolation.

7. The device of claim 1, wherein the NTN region has a lowered substrate doping than the PWell region.

8. The device of claim 7, wherein the doping of the NTN region is no more than about 10% of the doping of the PWell region or the NWell region, whichever has the lower doping.

9. The device of claim 8, wherein the NTN region increases an effective resistance in series with the PN junctions due to a lowered substrate doping.

10. The device of claim 1, wherein the NWell region has a decreased sidewall capacitance.

11. The device of claim 1, wherein a lower perimeter capacitance of the NWell perimeter improves a higher frequency performance of an NMOSFET inside the PWell region.

12. The device of claim 1, wherein the PWell region acts as a channel-stop.

13. The device of claim 1, wherein the PWell region acts as a channel-stop that breaks the formation of the parasitic native field-oxide NMOSFET.

14. The device of claim 1, further comprising:
at least one circuit inside the enclosed PWell region; and
at least one circuit external to the NWell region.

15. The device of claim 14, wherein the at least one circuit inside the PWell region includes a mosfet or a passive device.

16. The device of claim 14, wherein the at least one circuit external to the NWell region includes a mosfet or a passive device.

17. A CMOS device, comprising:
a n-type substrate;
a NWell region;
an isolation region that includes an PWell region abutting a perimeter of the NWell region, the isolation region including a Deep-PWell region positioned below the NWell region and a PWell region, the PWell region forming a sidewall of a tub and the Deep-PWell region forming a bottom of the tub, the tub being a p-type region that physically and electrically isolates an enclosed NWell region from the n-type substrate;
a NTN region formed in the n-type substrate and at least partially abutting an outer perimeter of the PWell region; and
wherein the NTN region enhances the electrical isolation of the circuits inside the isolated NWell region from the circuits outside the isolated NWell region.

18. The device of claim 17, wherein the NTN region is defined as a non-PWell and a non-NWell region.

19. The device of claim 17, wherein the NTN region is defined as a region without PWell implants and without the NWell implants.

20. A CMOS device, comprising:
a p-type substrate;
an NWell region;
a NTN region formed in the p-type substrate and at least partially abutting an outer perimeter of the NWell region;
wherein the NTN region enhances the electrical isolation of the circuits inside the NWell region from circuits outside the NWell region.

21. The device of claim 20, wherein the NTN region is defined as a non-PWell and a non-NWell region.

22. The device of claim 20, wherein the NTN region is defined as a region without PWell implants and without the NWell implants.

23. A CMOS device, comprising:
an n-type substrate;
a PWell region;
a NTN region formed in the n-type substrate and at least partially abutting an outer perimeter of the PWell region; and
wherein the NTN region enhances the electrical isolation of the circuits inside the PWell region from circuits outside the PWell region.

24. The device of claim 23, wherein the NTN region is defined as a non-PWell and a non-NWell region.

25. The device of claim 23, wherein the NTN region is defined as a region without PWell implants and without the NWell implants.
